(19) United States
(12) Patent Application Publication
(10) Pub. No.: US 2016/0307158 A1
(43) Pub. Date: Oct. 20, 2016

(54) AGGREGATING AND TRANSFORMING USER ACTIONS INTO SOCIAL SIGNAL FEATURES FOR A JOB RECOMMENDATION ENGINE

(71) Applicant: LinkedIn Corporation, Mountain View, CA (US)

(72) Inventors: Lijun Tang, Mountain View, CA (US); David Hardtke, Oakland, CA (US)

(21) Appl. No.: 14/688,579

(22) Filed: Apr. 16, 2015

(51) Int. Cl. G06Q 10/10; G06Q 50/00

(52) U.S. Cl. CPC G06Q 10/1053; G06Q 50/01

(57) ABSTRACT

A system stores member and job posting pairs in a database, which indicate that a job has been presented to a member, that the member has viewed the job posting, and that the member has applied for the job. The system extracts member attributes from a member profile and job attributes from a job posting file, and creates attribute pairs from the extracted member attributes and the extracted job attributes. The system creates an attribute tracking table, and for each job attribute in the attribute tracking table, create ratios relating to jobs that have been shown to members, jobs that members have viewed, and jobs for which members have applied. The system also determines trends between particular member attributes and particular job attributes. The ratios and trends are provided to a job recommendation engine that uses them in determining jobs to recommend to members.

### TECHNICAL FIELD

The subject matter disclosed herein relates to a job recommendation engine, and in an embodiment, but not by way of limitation, aggregating and transforming user actions on a social or business networking system into social signal features for use by a job recommendation engine.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, All Rights Reserved.

### BACKGROUND

A job recommendation engine generally operates in an online environment, and in many instances, a social networking or business networking environment. A job recommendation engine basically compares a member's profile data to data relating to jobs posted in the online environment, and recommends one or more posted jobs to members based on that comparison.

### SUMMARY

An online system stores member and job posting pairs in a database. Each member and job posting pair includes a vector. The vector indicates that a job posting has been presented to a member, indicates that the member has either viewed or not viewed the job posting, and indicates that the member has either applied for or not applied for the job posting.

For each member and job posting pair, the system extracts member attributes from a corresponding member profile and extracts job attributes from a corresponding job posting file.

The system creates attribute pairs from the extracted member attributes and the extracted job attributes. Each attribute pair includes the vector of a corresponding job posting pair.

The system uses the plurality of attribute pairs to create a job attribute tracking table by summing vectors associated with each particular job attribute. This generates for each particular job attribute a count of job postings that include the particular job attribute and that have been presented to members, a count of members who have viewed job postings that include the particular job attribute, and a count of members who have applied for job postings that include the particular job attribute.

For each particular job attribute in the job attribute tracking table, the system creates three ratios. The system creates a first ratio of the count of members who have applied for job postings that include the particular job attribute to the count of job postings that include the particular job attribute and that have been presented to members. The system creates a second ratio of the count of members who have applied for job postings that include the particular attribute to the count of job postings that include the particular job attribute and that have been viewed by members. The system creates a third ratio of the count of members who have viewed job postings that include the particular job attribute to the count of job postings that include the particular job attribute and that have been presented to members.

The system uses the attribute pairs to determine a count of each particular member attribute and job attribute pair, thereby indicating a trend between the particular member attribute and the particular job attribute.

The system provides the first ratio, the second ratio, and/or the third ratio to a job recommendation engine such that the job recommendation engine recommends job postings as a function of the first ratio, the second ratio, and/or the third ratio.

The system provides the trend between the particular member attribute and the particular job attribute to the job recommendation engine such that the job recommendation engine recommends job postings as a function of the trend between the particular member attribute and the particular job attribute.

### BRIEF DESCRIPTION OF THE DRAWINGS

Some embodiments are illustrated by way of example and not limitation in the figures of the accompanying drawings.

FIG. 1 is a block diagram of a system including user devices and a social network server.

FIG. 2 is a block diagram illustrating various components of a social network server.

FIG. 3 is a block diagram illustrating some of the various components of a social network server.

FIG. 4 illustrates an example relationship among a job recommendation engine, a (member, job) pair, and a vector associated with the (member, job) pair.

FIG. 5 illustrates an example record of a bi-attribute record.

FIGS. 6A and 6B are a flowchart of an example process of aggregating and transforming user actions into social signal features for use by a job recommendation engine.

FIGS. 7A and 7B are a block diagram illustrating features of a system for aggregating and transforming user actions into social signal features for use by a job recommendation engine.

FIG. 8 is a block diagram illustrating components of a machine that is able to read instructions from a machine-readable medium (e.g., a machine-readable storage medium) and perform any one or more of the methodologies discussed herein.

### DETAILED DESCRIPTION

Example methods and systems are directed to aggregating and transforming user actions into social signal features that can be used in a job recommendation engine. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A typical job recommendation engine compares a person's member profile data to the requirements for a job and may recommend that job to the person based on that comparison. However, such comparison and recommendation only takes into account the static data of the member's profile and the job requirements. Consequently, a system has been developed that analyzes user actions, and in particular user actions such as viewing a job with particular attributes and/or applying for a job with particular attributes, to determine social signal features that can be used in future job recommendations. In this way, a job recommendation can become more flexible and dynamic.

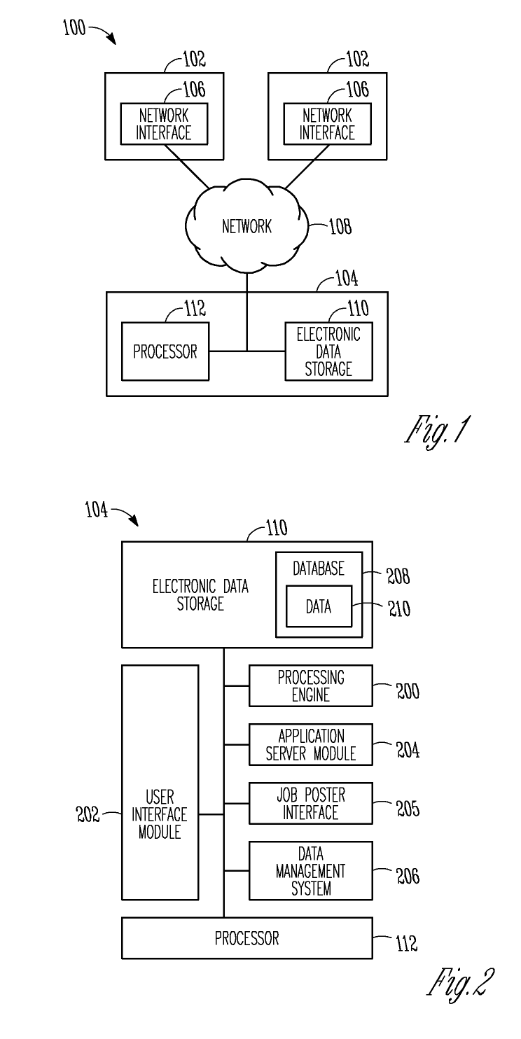

FIG. 1 is a block diagram of a system 100 including user devices 102 and a social network server 104. In an embodiment, a particular type of social network server can be referred to as a business network server. User devices 102 can be a personal computer, netbook, electronic notebook, smartphone, or any electronic device now known in the art or later developed that is configured to display web pages. The user devices 102 can include a network interface 106 that is communicatively coupled to a network 108, such as the Internet.

The social network server 104 can be communicatively coupled to the network 108. The server 104 can be an individual server or a cluster of servers, and can be configured to perform activities related to serving the social network, such as storing social network information, processing social network information according to scripts and software applications, transmitting information to present social network information to users of the social network, and receive information from users of the social network. The server 104 can include one or more electronic data storage devices 110, such as a hard drive, and can include a processor 112.

The social network server 104 can store information in the electronic data storage device 110 related to users and/or members of the social network, such as in the form of user characteristics corresponding to individual users of the social network. For instance, for an individual user, the user's characteristics can include one or more profile data points, including, for instance, name, age, gender, profession, prior work history or experience, educational achievement, location, citizenship status, leisure activities, likes and dislikes, and so forth. The user's characteristics can further include behavior or activities within and without the social network, as well as the user's social graph. For an organization, such as a company, the information can include name, offered products for sale, available job postings, organizational interests, forthcoming activities, and the like. For a particular available job posting, the job posting can include a job profile that includes one or more job characteristics, such as, for instance, area of expertise, prior experience, pay grade, residency or immigration status, and the like.

The ability to aggregate and transform user actions into social signal features for use in a job recommendation engine can be achieved with a general processing engine. Accordingly, at least in some examples, the general processing engine can provide the job recommendation service, and in other embodiments, can further provide a creation service (such as creating a job attribute table), or a calculation service (such as normalizing data relating to user actions). A processing entity can be a collection of information organized around a particular concept that is supported by the system 100 in general, such as storing member and job posting pairs in a database, extracting member attributes from a member profile and job attributes from a job posting file, creating attribute pairs from the extracted member attributes and the extracted job attributes, creating an attribute tracking table, creating ratios from member action data, and determining trends among the data.

The general processing engine may execute in real-time or as a background operation, such as offline or as part of a batch process. In some examples that incorporate relatively large amounts of data to be processed, the general processing engine may execute via a parallel or distributed computing platform.

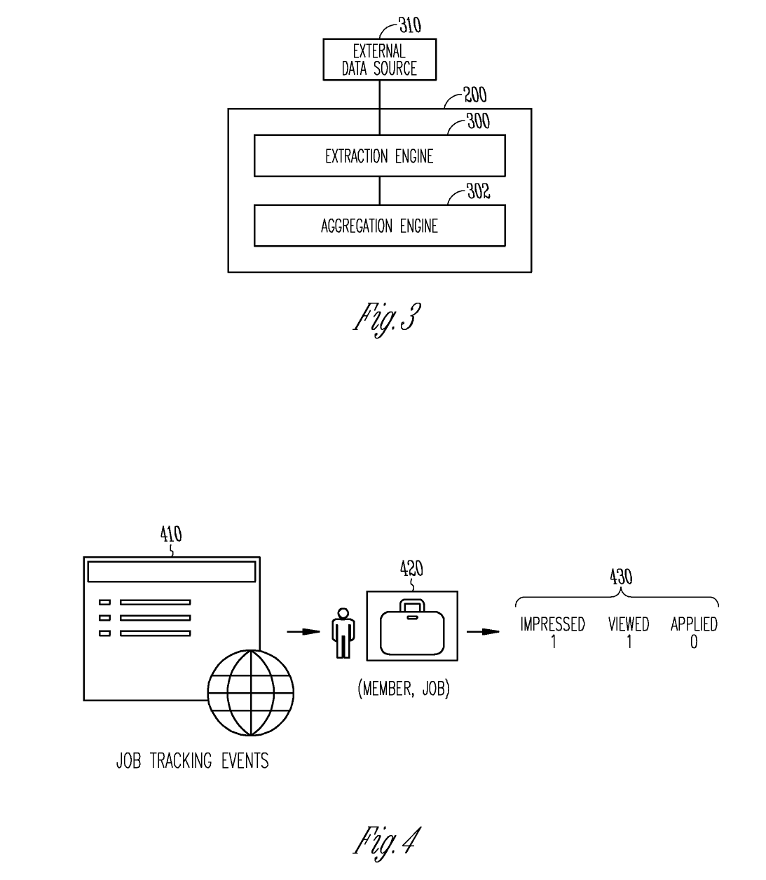

FIG. 2 is a block diagram illustrating various components of a social networking server 104 with a processing engine 200 for aggregating and transforming user actions into social signal features for use in a job recommendation engine. In an example, the social networking server 104 is based on a three-tiered architecture, consisting of a front-end layer, application logic layer, and data layer. As is understood by skilled artisans in the relevant computer and Internet-related arts, each module or engine shown in FIG. 2 can represent a set of executable software instructions and the corresponding hardware (e.g., memory and processor) for executing the instructions. To avoid obscuring the subject matter with unnecessary detail, various functional modules and engines that are not germane to conveying an understanding of the inventive subject matter have been omitted from FIG. 2. However, a skilled artisan will readily recognize that various additional functional modules and engines may be used with a social networking server 104 such as that illustrated in FIG. 2, to facilitate additional functionality that is not specifically described herein. Furthermore, the various functional modules and engines depicted in FIG. 2 may reside on a single server computer, or may be distributed across several server computers in various arrangements.

The front end of the social network server 104 consists of a user interface module (e.g., a web server) 202, which receives requests from various client computing devices, and communicates appropriate responses to the requesting client devices. For example, the user interface module(s) 202 may receive requests in the form of Hypertext Transport Protocol (HTTP) requests, or other web-based, application programming interface (API) requests. The application logic layer includes various application server modules 204, which, in conjunction with the user interface module(s) 202, generates various user interfaces (e.g., web pages) with data retrieved from various data sources in the data layer. With some embodiments, individual application server modules 204 are used to implement the functionality associated with various services and features of the system 100. For instance, the ability to identify and trend user action data may be a service implemented in an independent application server module 204. Similarly, other applications or services that utilize the processing engine 200 may be embodied in their own application server modules 204.

The data layer 110 can include several databases, such as a database 208 for storing data 210 such as job profiles, general employee profiles, specific employee profiles, company profiles, and job postings, and can further include additional social network information, such as interest groups, companies, advertisements, events, news, discussions, tweets, questions and answers, and so forth. In some examples, the data are processed in the background (e.g., offline) to generate pre-processed data that can be used by the processing engine, in real-time, and to make recommendations or report results generally. In an example, the processing engine 200 may calculate ratios based on user action data, may normalize that data, may determine trends in that data, and may provide such ratios and trends to a job recommendation function of the processing engine 200 or a stand alone job recommendation engine. These examples merely typify possible variations.

In various examples, when a person initially registers to become a user (and/or member) of the system 100, the person can be prompted to provide some personal information, such as his or her name, age (such as by birth date), gender, interests, contact information, home town, address, the names of the user's spouse and/or family users, educational background (such as schools, majors, etc.), employment history, skills, professional organizations, and so on. This information can be stored, for example, in the database 208.

The server 104 can also include a job poster interface 205, such as with a user interface coupled to the server 104 or via the network interface 106. The user interface can include a conventional keyboard and display configuration well known in the art. The job poster interface 205 provides an interface for the posting of jobs, including a corresponding job profile, on the social network.

The job poster interface 205 is coupled to a data management system 206. The data management system 206 can incorporate data management technologies well known in the art or can incorporate proprietary data management structures. In an example, the data management system 206 incorporates SAS, or Statistical Analysis System data management systems, to promote business analysis, statistical analysis, data storage and recovery, and the like for job, company, and employee (member) information. The data management system 206 can include the capacity for social network administrators to utilize the data generated by the data management system 206, such as by inputting tasks into the data management system 206.

The job poster interface 205 and the data management system 206 can both be coupled to the database 208. The job poster interface 205 can transmit job data, such as job profiles, to the database 208 for storage without respect to data management activities. The data management system 206 can store job data in the database 208 upon the job data having been acted upon for data management analysis.

The network interface 106 can provide the input of user data, such as user characteristics or profile data, into the social network. The user data can be stored in the database 208 or can be directly transmitted to the processing engine 200 for processing. Jobs posting and other data and results identified by or processed by the processing engine 200 can be transmitted via the network interface 106 to the user device 102 for presentation to the user.

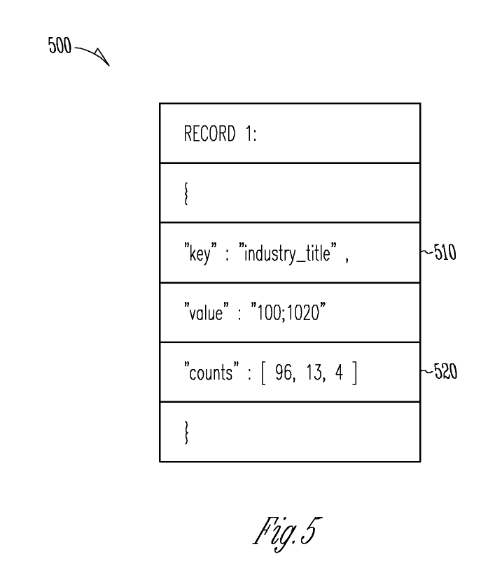

FIG. 3 is a block diagram showing some of the functional components or modules that comprise a processing engine 200, in some examples, and illustrates the flow of data that occurs when performing various operations of a method for aggregating and analyzing user data to determine social signal features for use in a job recommendation engine. As illustrated, the processing engine 200 consists of two primary functional modules—an extraction engine 300 and an aggregation engine 302, and can be coupled to an external data source 310. The extraction engine 300 can extract data from a user profile, a company profile, an employee profile of a business organization, a job posting, and a job profile, and then the aggregation engine 302 can group and aggregate different member features and/or job attribute features.

An embodiment works in conjunction with and complements a job recommendation engine of a social and/or business networking system, such as illustrated in FIGS. 1, 2, and 3, and can be incorporated into existing modeling techniques of a job recommendation engine.

As noted above, a typical job recommendation engine predominantly uses text content matching features derived from job postings on a social networking system and profiles of the members of the social networking system. That is, the job recommendation engine focuses on static content without considering dynamic social signals that can be gleaned from members' past behavior patterns. These social signals can be important determining factors that drive a member to apply for a particular job. However, these social signals cannot be easily extracted from text content alone.

Consequently, in an embodiment, a framework provides a simple and intuitive way to compute such social signals, and use the social signals as predictive features for a job recommendation engine. The social signals fall into two main categories. The first category is the popularity of job attributes (e.g., the popularity of a company, an industry, a job title, a job function, and a job location). The second category is the transition trend between a member attribute and a job attribute (e.g., transition trend of a member's current company to a job's company, transition trend of a member's current title to a job's title, transition trend of a member's current geographical location to a job's geographical location, and transition trend of a member's latest school to a job's company). Using these social signals as features in a machine learning system, these signals can significantly improve a job recommendation engine's business metrics, such as the job applies per impression.

A job recommendation engine typically tracks data for each job that it has ever shown to members of a social networking system. Therefore, each (member, job) pair in the tracked data set is an impression event, which indicates that the job recommendation engine has shown the job to the member. The job recommendation engine can also track view events, that is, the member has clicked the job snippet to view the job details page. The job recommendation engine can further track apply events, that is, the member has clicked the apply button in the job details page to apply for the job.

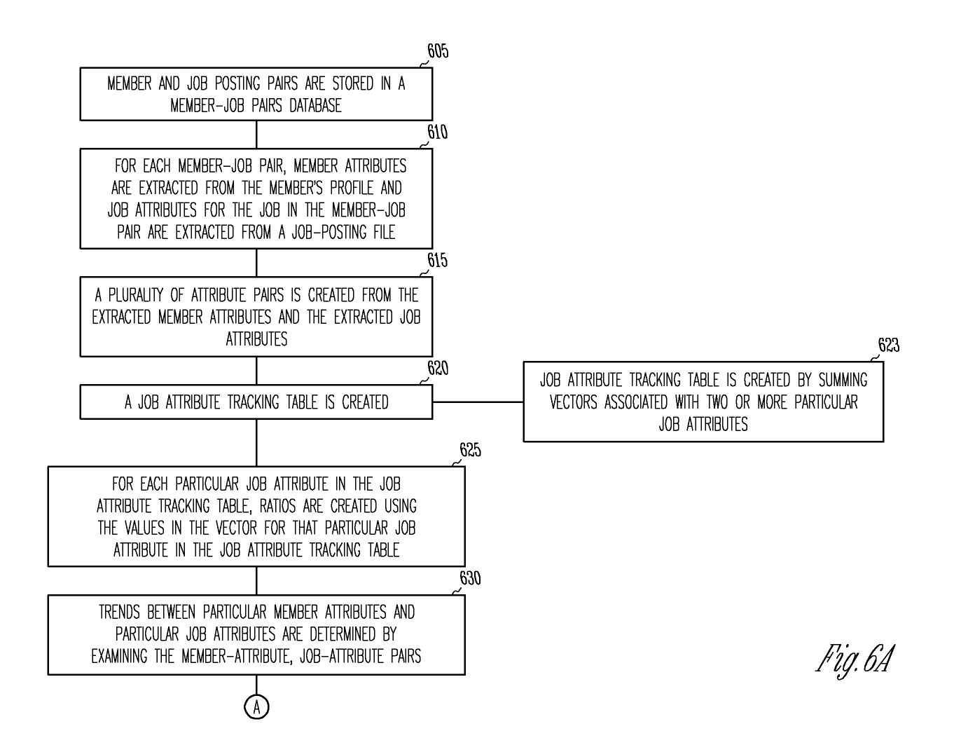

More particularly, a job recommendation engine collects historical impressions as defined by (member, job) pairs from its tracking data. The (member, job) pair is associated with a vector that indicates that a particular job has been presented to, shown to, or impressed upon a member. The vector further indicates whether the member has clicked on and viewed the job and whether the member has clicked on and applied for the job. This information stored in the vector can therefore take the following form—(impressed, viewed, applied), and can be referred to as an integer tracking tuple. A tuple is created and stored for each (member, job) pair, wherein impressed is equal to 1 for all the job pairs; viewed is equal to 1 if the member viewed the job, or it is equal to 0 if the member has not viewed the job; applied is equal to 1 if the member has applied for the job, or applied is equal to 0 if the user has not clicked on and applied for the job. FIG. 4 illustrates a diagram of constructing a (member, job) pair 420 from tracked events 410 in a social networking system, wherein the impressed, viewed, and applied values 430 of this (member, job) pair are equal to (1, 1, 0) respectively.

From a job posting, the job recommendation engine (or processing engine 200) can extract job attributes. Similarly, from a member profile, the job recommendation engine can extract member attributes. The (member, job) pair can then be expanded into (member attributes, job attributes) tuples, thereby generating an attribute-based tracking table as follows—(member attributes, job attributes)→(impressed, viewed, applied).

The job attribute popularity features can be calculated as follows. A first step of aggregating is executed. The attribute-based tracking table is grouped by an individual job attribute or a combination of multiple attributes, and all the tracking tuples for each group are summed up to get job attribute counts as follows:

```
Job_attribute₁ → (total_impressed, total_viewed, total_applied)
Job_attribute₂ → (total_impressed, total_viewed, total_applied)
  .
  .
  .
Job_attributeᵢ → (total_impressed, total_viewed, total_applied)
Job_attribute_{i—}attributeⱼ → (total_impressed, total_viewed,
```

total_applied)

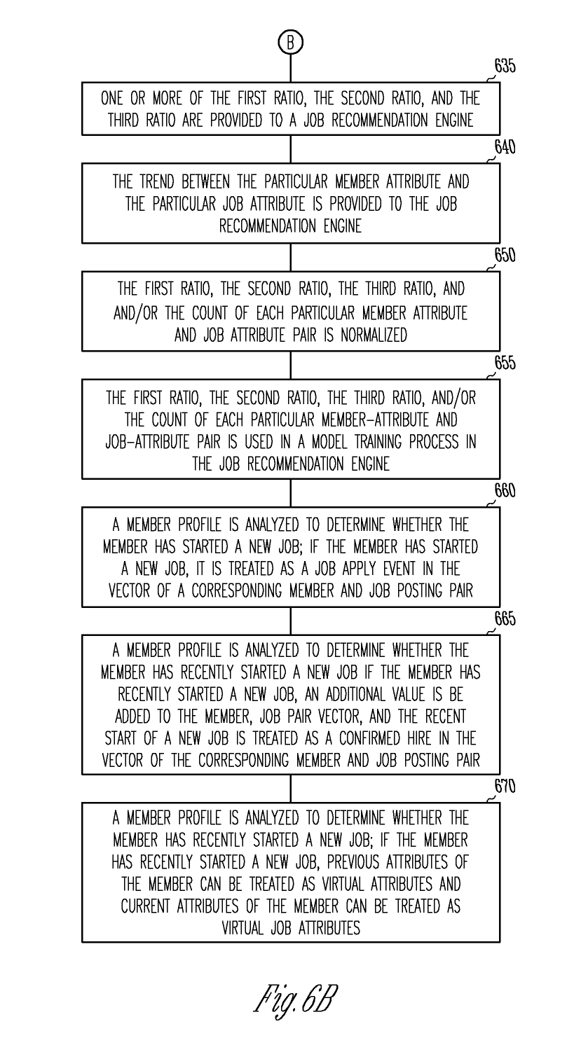

For example, job_attribute₁ could be a job company, job_attribute₂ could be a job industry, job_attributeᵢ_{_}attributeⱼ could be the combination of job title and job geographic location, etc. FIG. 5 illustrates a sample record 500 for a bi-attribute industry_title 510, i.e., both a job industry and job title, where the value is the tuple (industryId, jobTitleId) concatenated by semicolon, and wherein counts 520 are (total_impressed, total_viewed, total_applied) for the bi-attribute. Therefore, in the bi-attribute illustrated in FIG. 5, ninety-six (member, job) pairs that have a particular job title in a particular job industry have been impressed upon members, thirteen (member, job) pairs have viewed jobs with those two particular attributes, and four (member, job) pairs have applied for jobs with those two particular attributes.

In an embodiment, the counts of the tuples are transformed into ratios. Such ratios can include applies per impression (API), applies per view (APV), and views per impression (VPI). These ratios can be calculated as follows by dividing two counts of a same attribute:

API_job_attributeᵢ=total_applied/total_impressed

APV_job_attributeᵢ=total_applied/total_viewed

VPI_job_attributeᵢ=total_viewed/total_impressed

Consequently, each attribute can have three ratios with a range of [0, 1].

A smoothing and normalizing function can be applied to the ratios. Consequently, instead of using the ratios directly, the ratios are smoothed by adding some constant positive number to the counts, taking the logarithm of the ratio, and normalizing it back to the range of [0,1]. For example, as follows:

LOG_API_job_attributeᵢ=1+α*[log(β+total_applied)−log(γ+total_impressed)]

LOG_APV_job_attributeᵢ=1+α*[log(β+total_applied)−log(γ+total_viewed)]

LOG_VPI_job_attributeᵢ=1+α*[log(β+total_viewed)−log(γ+total_impressed)]

Wherein α, β, and γ are three constant smoothing parameters that are determined empirically, with constraints 0<α<1, 0<β<1, and γ>1. These are the final job attribute popularity features to be used in the model training process. One way to determine the values of the parameters is to plot a distribution of different parameter values with raw counts, and then select the parameter values that best fits the curve to a normal distribution. In an embodiment, after the parameter values are determined (e.g., α=0.08, β=0.0001, and γ=5), they are fixed and the model training process will not change them.

Additionally, in another embodiment, a member attribute can be crossed with a job attribute to form a number of (member attribute, job attribute) pairs and aggregate their tracking tuples for each unique pair. This crossing captures the transition trend between a member attribute and a job attribute. Each (member attributes, job attributes)→(impressed, viewed, applied) can be cross applied into a number of rows with the same tracking tuple as follows:
(member_attribute₁, job_attribute₁)→(impressed, viewed, applied)
(member_attribute₂, job_attribute₂)→(impressed, viewed, applied)
(member_attribute₃, job_attribute₃)→(impressed, viewed, applied)
   Then, the (member, job attribute) pairs are grouped and the tracking tuples are summed as follows:

(member_attribute₁, job_attribute₁) → (total_impressed,

total_viewed, total_applied)

(member_attribute₂, job_attribute₂) → (total_impressed,

total_viewed, total_applied)

.
.
.
(member_attributeᵢ, job_attributeⱼ) −> (total_impressed,

total_viewed, total_applied)

Once again, the tuples can be transformed and smoothed as follows:

LOG_API_member_attrbuteᵢ_{_{—job}}_attributeⱼ=1+α*[log(β+total_applied)−log(γ+total_impressed)]

LOG_APV_member_attrbuteᵢ_{_{—job}}_attributeⱼ=1+α*[log(β+total_applied)−log(γ+total_viewed)]

LOG_VPI_member_attrbuteᵢ_{_{—job}}_attributeⱼ=1+α*[log(β+total_viewed)−log(γ+total_impressed)]

Both job attribute popularity features and (member attribute, job attribute) transition features are normalized numeric features proving valuable social signals mined from historical member behavior data on the social networking system. They can be added into existing text content matching features to train a model that captures both text content relevance and social trends.

With this framework, a (member, job) tracking table can further be enriched by utilizing tracking data across an entire social networking system. For example, members' job change events can be filtered from members' profile change events, which can then be used as implicit job apply events. Alternatively, members' job change events could be used to define a new confirmed hire event in the tuples. To incorporate the job change events into an existing framework, members' previous job attributes can be regarded as virtual member attributes, and members' current job attributes can be regarded as virtual job attributes. This treatment is useful as it provides extra perdition horsepower for those jobs whose attributes have rarely been seen in a job recommendation engine's historical tracking data.

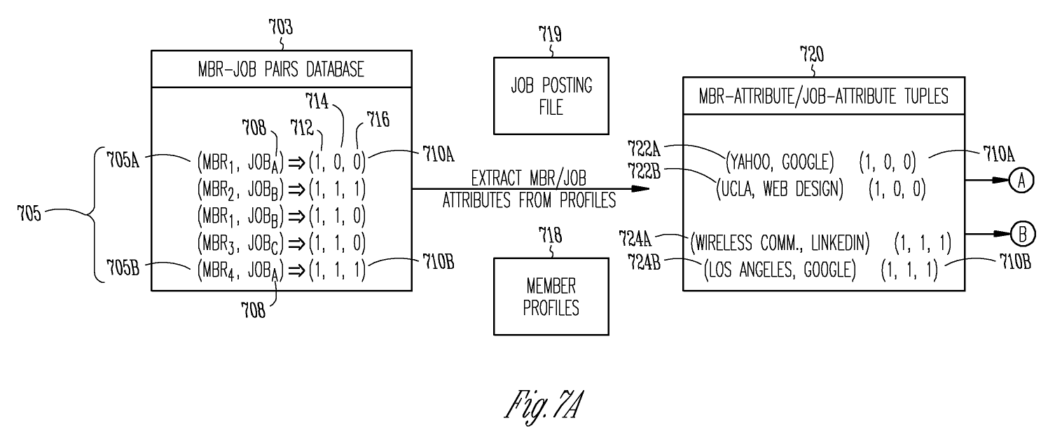

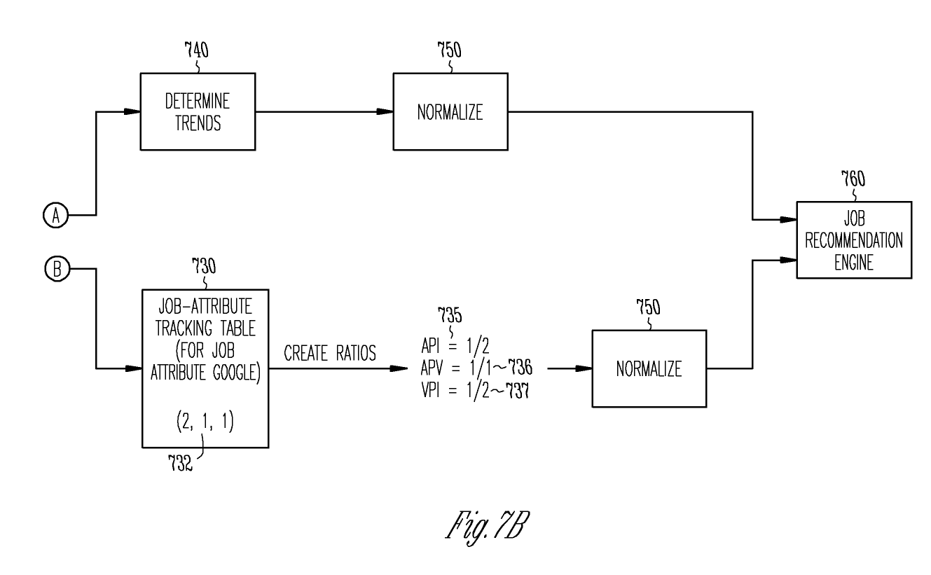

FIGS. 6A and 6B are a flowchart-like diagram of features and steps of an example process for aggregating and transforming user actions into social signal features for a job recommendation engine. FIGS. 6A and 6B include a number of process blocks 605-670. Though arranged serially in the example of FIGS. 6A and 6B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations. FIG. 7 is a pictorial representation of the process of FIGS. 6A and 6B.

Referring to FIGS. 6A, 6B, 7A, and 7B, at 605, member and job posting pairs 705 are stored in a member-job pairs database 703 in a network-based social and/or business networking system. The network can include the Internet. As illustrated in FIG. 7A, each member and job posting pair 705 includes a vector, e.g., vector 710A, 710B. Each vector indicates at 712 that a job posting has been presented to a member, indicates at 714 that the member has either viewed or not viewed the job posting, and indicates at 716 that the member has either applied for or not applied for the job posting. As disclosed above, a value of ‘1’ can be used to indicate that a job posting has been presented to (or impressed upon) the member, that the member has clicked on and viewed the job posting, and that the member has applied for the job described in the job posting. As also described above, a value of ‘0’ can be used to indicate that a member has not clicked on and viewed the job posting, and that the member has not applied for the job described in the job posting.

Referring back to FIGS. 6A and 6B, at 610, for each member-job pair 705 in the member-job pairs database 703, member attributes are extracted from the member's profile 718 and job attributes for the job in the member-job pair are extracted from a job-posting file or database 719. At 615, a plurality of attribute pairs 720 is created from the extracted member attributes and the extracted job attributes. Each attribute pair 722A, 722B, 724A, and 724B is associated with the vector of its corresponding member-job job posting pair 705. For example, referring to FIG. 7A, a first member-attribute, job-attribute pair 722A includes (Yahoo, Google), and is associated with a vector 710A whose values are (1, 0, 0). That is, the member's profile 718 indicates that the member currently is employed at Yahoo, and the job posting file 719 indicates that the job presented to the member is at Google. The vector 710A with its values of (1, 0, 0) is taken from (or shared with) the vector 710A of the original member-job pair 705A. Similarly, a second member-attribute, job-attribute pair 722B includes (UCLA, web design), and further includes the same vector 710A with values of (1, 0, 0) since this member-attribute, job-attribute pair 722B originated from the same member, job pair 705A. This member-attribute, job-attribute pair 722B indicates that the member attended UCLA, and that the job presented to the user is related to web design. Many more member-attribute, job-attribute pairs could be generated for this particular member-job pair 705A by extracting more attributes for this member from his or her member profile 718 and extracting more attributes from the job posting file 719. FIG. 7A illustrates two other member-attribute, job-attribute pairs at 724A and 724B, which were created using the member profile 718 and job posting file 719 associated with the member and job posting of the member-job pair 705B, and wherein the member-attribute pair 724B includes vector 710B that shares the same values as member-job pair 705B.

At 620, a job attribute tracking table 730 is created as follows. Using the plurality of member-attribute, job-attribute pairs 720, the vectors for each particular job attribute are summed. For example, in FIG. 7A, the vector 710A, 710B for each member-attribute, job-attribute pair that has ‘Google’ as the job attribute (i. e, 722A, 724B) is summed, and this is placed into the job attribute tracking table 730 for the job attribute ‘Google.’ In FIG. 7A, there are two member-attribute, job-attribute pairs 722A, 724B that include ‘Google’ as the job attribute, and the sum of the vectors for these two member-attribute, job-attribute pairs is (1, 0, 0) from 710A and (1, 1, 1) from 710B for a summation of (2, 1, 1), as indicated at 732 in FIG. 7B. The summing of vectors associated with each particular job attribute generates for each particular job attribute a count of job postings that include the particular job attribute and that have been presented to members, a count of members who have viewed job postings that include the particular job attribute, and a count of members who have applied for job postings that include the particular job attribute. Therefore, in the example just presented, two jobs from Google have been presented to members, one member has viewed a job from Google, and one member has applied for a job at Google. In this particular example, the job attribute tracking table 730 was created from the same job 708 that was posted to two different members (i.e., member₁ and member₄). However, there are many other combinations that are possible from the job posting pairs 705, such as the same member being presented with multiple jobs from the same company, the same member being presented with multiple jobs from different companies, different members being presented with different jobs from the same company, different members being presented with the same job from the same company, etc.

In a particular embodiment, as indicated at 623, the job attribute tracking table is created by summing vectors associated with two or more particular job attributes, instead of just the one attribute as indicated at operation block 620. By summing vectors associated with two or more attributes, the following are generated for the particular two job attributes. First, a count of job postings that include the two or more particular job attributes that have been presented to members. Second, a count of members who have viewed job postings that include the two or more particular job attributes. Third, a count of members who have applied for job postings that include the two or more particular job attributes.

At 625, for each particular job attribute 732 in the job attribute tracking table 730, ratios are created using the values in the vector for that particular job attribute in the job attribute tracking table. At 735, a first ratio is the count of members who have applied for job postings that include the particular job attribute to the count of job postings that include the particular job attribute and that have been presented to members (i.e, applies per impression (API)). At 736, a second ratio is the count of members who have applied for job postings that include the particular job attribute to the count of job postings that include the particular job attribute and that have been viewed by members (i.e., applies per view (APV)). At 737, a third ratio is the count of members who have viewed job postings that include the particular job attribute to the count of job postings that include the particular job attribute and that have been presented to members (i.e., views per impression (VPI)). For example, as illustrated in FIG. 7B, at 735, the first ratio, which as noted can be referred to as an applies per impression ratio (API), the number of applies for the Google job is 1, and the number of times that the Google job was presented to a member was 2, so the first ratio of applies per impression is ½. Similarly, the second ratio at 736, which as noted can be referred to as applies per view (APV), the number of applies for the Google job is 1, and the number of views of the Google job is 1, so the second ratio is 1/1. The third ratio at 737, which as noted can be referred to as the views per impression ratio (VPI), the number of views is 1, the number of impressions is 2, so the views per impression is ½.

At 630, 740, trends between particular member attributes and particular job attributes are determined by examining the member-attribute, job-attribute pairs in database 720. Specifically, a count of each particular member-attribute and job-attribute pair is determined, and if the count is large compared to other counts or to a threshold, then that particular member-attribute and job-attribute pair may indicate a trend. For example, if there are many member-attribute, job-attribute pairs of (Yahoo, LinkedIn), that indicates one or more of a trend of members from Yahoo being shown jobs from LinkedIn, members from Yahoo viewing jobs from LinkedIn, and/or members from Yahoo applying for jobs at LinkedIn.

At 635, one or more of the first ratio, the second ratio, and the third ratio are provided to a job recommendation engine 760. The job recommendation engine then recommends one or more job postings to one or more members as a function of the first ratio, the second ratio, and/or the third ratio. For example, a high API ratio 735 indicates that job postings with a particular job attribute generate a good number of applies per impression, and future job postings with that particular job attribute may be given preference in future job impressions. Also, a high APV ratio 736 indicates that job postings with that particular job attribute have a high number of job applicants per view, indicating a high interest in jobs that include that job attribute, and this may also be taken into account in future job impressions to members. Similarly, a high VPI ratio 737 indicates a large number of views per impression, which indicates many members may be interested in jobs with this particular job attribute, and this may similarly be taken into account in future job impressions to members.

At 640, the trend between the particular member attribute and the particular job attribute is provided to the job recommendation engine 760. The job recommendation engine recommends one or more job postings as a function of the trend between the particular member attribute and the particular job attribute.

At 650, 750, the first ratio, the second ratio, the third ratio, and and/or the count of each particular member attribute and job attribute pair is normalized. In an embodiment, this normalization can be implemented as follows:

normalized_first_ratio=1+α*[log(β+total_applied)−log(γ+total_presented)]

normalized_second_ratio=1+α *[log(β+total_applied)−log(γ+total_viewed)]

normalized_third_ratio=1+α*[log(β+total_viewed)−log(γ+total_presented)]

normalized_count_memberjob_pair=1+α*[log(β+total_applied)−log(γ+total_shown)]

The terms α, β, and γ are empirically determined constant smoothing parameters. The factors that are considered when empirically determining the values of these constants include the statistics of the raw counts, such as maximum, minimum, average, etc. It is helpful to make the normalized ratio approximate a normal distribution as much as possible. The gamma factor penalizes ratios with a low confidence (e.g. only a few total impressions). The term total_presented is the count of job postings that include the particular job attribute that have been presented to members, the term total_viewed is the count of members who have viewed job postings that include the particular job attribute, and the term total_applied is the count of members who have applied for job postings that include the particular attribute.

At 655, the first ratio, the second ratio, the third ratio, and/or the count of each particular member-attribute and job-attribute pair is used in a model training process in the job recommendation engine 760.

At 660, a member profile is analyzed to determine whether the member has started a new job. If the member has started a new job, that is treated as a job apply event in the vector of a corresponding member and job posting pair.

At 665, a member profile is analyzed to determine whether the member has recently started a new job. If the member has recently started a new job, an additional value can be added to the member, job pair vector, and the recent start of a new job can be treated as a confirmed hire in the vector of the corresponding member and job posting pair. For example, vector 710B could be changed to (1, 1, 1, 1) to indicate that a job was shown to member₄, member₄ viewed the job, member₄ applied for the job, and member₄ was hired for that job.

At 670, a member profile is analyzed to determine whether the member has recently started a new job. If the member has recently started a new job, previous attributes of the member can be treated as virtual attributes and current attributes of the member can be treated as virtual job attributes. An implication here is that most members' current positions are originally from a certain job position, even if the job might not been posted on a particular social networking website. By retrospectively examining when a member held his or her previous job position, he or she most likely applied for a job that led to his or her current position at some point in time.

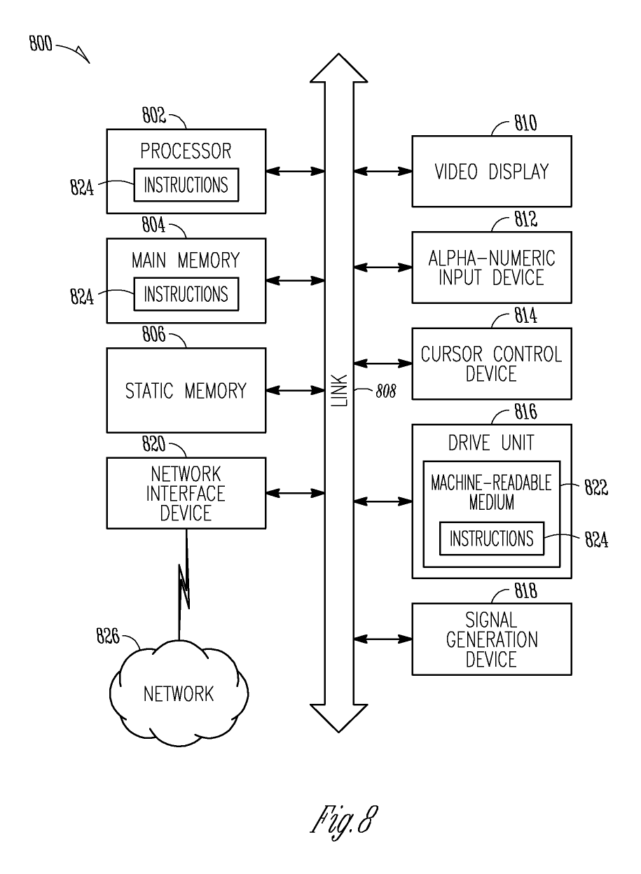

FIG. 8 is a block diagram illustrating components of a machine 800, according to some example examples, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software) for causing the machine 800 to perform any one or more of the methodologies discussed herein may be executed. In alternative examples, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A social networking system comprising:
a computer processor configured to:
store member and job posting pairs in a database, each member and job posting pair comprising a vector, each vector indicating that a job posting has been presented to a member, indicating that the member has either viewed or not viewed the job posting, and indicating that the member has either applied for or not applied for the job posting;
for each member and job posting pair, extract one or more member attributes from a corresponding member profile and extract one or more job attributes from a corresponding job posting file;
create a plurality of attribute pairs from the extracted member attributes and the extracted job attributes, each attribute pair comprising the vector of a corresponding job posting pair;
using the plurality of attribute pairs, create a job attribute tracking table by summing vectors associated with each particular job attribute, thereby generating for each particular job attribute a count of job postings that include the particular job attribute and that have been presented to members, a count of members who have viewed job postings that include the particular job attribute, and a count of members who have applied for job postings that include the particular job attribute;
for each particular job attribute in the job attribute tracking table,
create a first ratio of the count of members who have applied for job postings that include the particular job attribute to the count of job postings that include the particular job attribute and that have been presented to members;
create a second ratio of the count of members who have applied for job postings that include the particular job attribute to the count of job postings that include the particular job attribute and that have been viewed by members; and
create a third ratio of the count of members who have viewed job postings that include the particular job attribute to the count of job postings that include the particular job attribute and that have been presented to members;
using the plurality of attribute pairs, determine a count of each particular member attribute and job attribute pair, thereby indicating a trend between the particular member attribute and the particular job attribute;
provide one or more of the first ratio, the second ratio, and the third ratio to a job recommendation engine such that the job recommendation engine recommends one or more job postings as a function of one or more of the first ratio, the second ratio, and the third ratio; and
provide the trend between the particular member attribute and the particular job attribute to the job recommendation engine such that the job recommendation engine recommends one or more job postings as a function of the trend between the particular member attribute and the particular job attribute.

2. The social networking system of claim 1, wherein the computer processor is configured to create the job attribute tracking table by summing vectors associated with two or more particular job attributes, thereby generating for the two or more particular job attributes a count of job postings that include the two or more particular job attributes that have been presented to members, a count of members who have viewed job postings that include the two or more particular job attributes, and a count of members who have applied for job postings that include the two or more particular job attributes.

3. The social networking system of claim 1, wherein the computer processor is configured to normalize one or more of the first ratio, the second ratio, the third ratio, and the count of each particular member attribute and job attribute pair.

4. The social networking system of claim 3, wherein the first ratio, the second ratio, the third ratio, and the count of each particular member attribute and job attribute pair are normalized as follows:
normalized_first_ratio=1+α*[log(β+total_applied)−log(γ+total_presented)];
normalized_second_ratio=1+α*[log(β+total_applied)−log(γ+total_viewed)];
normalized_third_ratio=1+α*[log(β+total_viewed)−log(γ+total_presented)]; and
normalized_count_memberjob_pair=1+α*[log(β+total_applied)−log(γ+total_shown)];
wherein α, β, and γ are empirically determined constant smoothing parameters;
wherein total_presented is the count of job postings that include the particular job attribute that have been presented to members;
wherein total_viewed is the count of members who have viewed job postings that include the particular job attribute; and
wherein total_applied is the count of members who have applied for job postings that include the particular attribute.

5. The social networking system of claim 1, wherein the computer processor is configured to use one or more of the first ratio, the second ratio, the third ratio, and the count of each particular member attribute and job attribute pair in a model training process in the job recommendation engine.

6. The social networking system of claim 1, wherein the computer processor is configured to analyze a member profile, to determine that the member has started a new job, and to treat the start of the new job by the member as a job apply event in the vector of a corresponding member and job posting pair.

7. The social networking system of claim 1, wherein the computer processor is configured to analyze a member profile, to determine that the member has started a new job, and to treat the start of the new job as a confirmed hire in the vector of a corresponding member and job posting pair.

8. The social networking system of claim 1, wherein the computer processor is configured to analyze a member profile, to determine that a member has started a new job, and to treat previous attributes of the member as virtual attributes and to treat current attributes of the member as virtual job attributes.

9. The social networking system of claim 1, wherein the computer processor is configured to extract the member attributes from one or more of a resume, a curriculum vitae, and an aggregated professional history.

10. A computer readable medium comprising instructions that when executed by a processor execute a process comprising:
storing member and job posting pairs in a database, each member and job posting pair comprising a vector, each vector indicating that a job posting has been presented to a member, indicating that the member has either viewed or not viewed the job posting, and indicating that the member has either applied for or not applied for the job posting;
for each member and job posting pair, extracting one or more member attributes from a corresponding member profile and extracting one or more job attributes from a corresponding job posting file;
creating a plurality of attribute pairs from the extracted member attributes and the extracted job attributes, each attribute pair comprising the vector of a corresponding job posting pair;
using the plurality of attribute pairs, creating a job attribute tracking table by summing vectors associated with each particular job attribute, thereby generating for each particular job attribute a count of job postings that include the particular job attribute and that have been presented to members, a count of members who have viewed job postings that include the particular job attribute, and a count of members who have applied for job postings that include the particular job attribute;
for each particular job attribute in the job attribute tracking table,
creating a first ratio of the count of members who have applied for job postings that include the particular job attribute to the count of job postings that include the particular job attribute and that have been presented to members;
creating a second ratio of the count of members who have applied for job postings that include the particular job attribute to the count of job postings that include the particular job attribute and that have been viewed by members; and
creating a third ratio of the count of members who have viewed job postings that include the particular job attribute to the count of job postings that include the particular job attribute and that have been presented to members;
using the plurality of attribute pairs, determining a count of each particular member attribute and job attribute pair, thereby indicating a trend between the particular member attribute and the particular job attribute;
providing one or more of the first ratio, the second ratio, and the third ratio to a job recommendation engine such that the job recommendation engine recommends one or more job postings as a function of one or more of the first ratio, the second ratio, and the third ratio; and
providing the trend between the particular member attribute and the particular job attribute to the job recommendation engine such that the job recommendation engine recommends one or more job postings as a function of the trend between the particular member attribute and the particular job attribute.

11. The computer readable medium of claim 10, comprising instructions for creating the job attribute tracking table by summing vectors associated with two or more particular job attributes, thereby generating for the two or more particular job attributes a count of job postings that include the two or more particular job attributes that have been presented to members, a count of members who have viewed job postings that include the two or more particular job attributes, and a count of members who have applied for job postings that include the two or more particular job attributes.

12. The computer readable medium of claim 10, comprising instructions for normalizing one or more of the first ratio, the second ratio, the third ratio, and the count of each particular member attribute and job attribute pair.

13. The computer readable medium of claim 12, wherein the first ratio, the second ratio, the third ratio, and the count of each particular member attribute and job attribute pair are normalized as follows:
normalized_first_ratio=1+α*[log(β+total_applied)−log(γ+total_presented)];
normalized_second_ratio=1+α*[log(β+total_applied)−log(γ+total_viewed)];
normalized_third_ratio=1+α*[log(β+total_viewed)−log(γ+total_presented)]; and
normalized_count_memberjob_pair=1+α*[log(β+total_applied)−log(γ+total_shown)];
wherein α, β, and γ are empirically determined constant smoothing parameters;
wherein total_presented is the count of job postings that include the particular job attribute that have been presented to members;
wherein total_viewed is the count of members who have viewed job postings that include the particular job attribute; and
wherein total_applied is the count of members who have applied for job postings that include the particular attribute.

14. The computer readable medium of claim 10, comprising instructions for using one or more of the first ratio, the second ratio, the third ratio, and the count of each particular member attribute and job attribute pair in a model training process in the job recommendation engine.

15. The computer readable medium of claim 10, comprising instructions for analyzing a member profile, for determining that the member has started a new job, and for treating the start of the new job by the member as a job apply event in the vector of a corresponding member and job posting pair.

16. The computer readable medium of claim 10, comprising instructions for analyzing a member profile, for determining that the member has started a new job, and for treating the start of the new job as a confirmed hire in the vector of a corresponding member and job posting pair.

17. The computer readable medium of claim 1, comprising instructions for analyzing a member profile, for determining that a member has started a new job, and for treating previous attributes of the member as virtual attributes and to treat current attributes of the member as virtual job attributes.

18. The computer readable medium of claim 10, comprising instructions for extracting the member attributes from one or more of a resume, a curriculum vitae, and an aggregated professional history.

19. A process comprising:
storing member and job posting pairs in a database, each member and job posting pair comprising a vector, each vector indicating that a job posting has been presented to a member, indicating that the member has either viewed or not viewed the job posting, and indicating that the member has either applied for or not applied for the job posting;
for each member and job posting pair, extracting one or more member attributes from a corresponding member profile and extracting one or more job attributes from a corresponding job posting file;
creating a plurality of attribute pairs from the extracted member attributes and the extracted job attributes, each attribute pair comprising the vector of a corresponding job posting pair;
using the plurality of attribute pairs, creating a job attribute tracking table by summing vectors associated with each particular job attribute, thereby generating for each particular job attribute a count of job postings that include the particular job attribute and that have been presented to members, a count of members who have viewed job postings that include the particular job attribute, and a count of members who have applied for job postings that include the particular job attribute;
for each particular job attribute in the job attribute tracking table,
creating a first ratio of the count of members who have applied for job postings that include the particular job attribute to the count of job postings that include the particular job attribute and that have been presented to members;
creating a second ratio of the count of members who have applied for job postings that include the particular job attribute to the count of job postings that include the particular job attribute and that have been viewed by members; and
creating a third ratio of the count of members who have viewed job postings that include the particular job attribute to the count of job postings that include the particular job attribute and that have been presented to members;
using the plurality of attribute pairs, determining a count of each particular member attribute and job attribute pair, thereby indicating a trend between the particular member attribute and the particular job attribute;
providing one or more of the first ratio, the second ratio, and the third ratio to a job recommendation engine such that the job recommendation engine recommends one or more job postings as a function of one or more of the first ratio, the second ratio, and the third ratio; and
providing the trend between the particular member attribute and the particular job attribute to the job recommendation engine such that the job recommendation engine recommends one or more job postings as a function of the trend between the particular member attribute and the particular job attribute.

20. The process of claim 19, comprising creating the job attribute tracking table by summing vectors associated with two or more particular job attributes, thereby generating for the two or more particular job attributes a count of job postings that include the two or more particular job attributes that have been presented to members, a count of members who have viewed job postings that include the two or more particular job attributes, and a count of members who have applied for job postings that include the two or more particular job attributes.
